(19) United States
(12) Patent Application Publication
(10) Pub. No.: US 2025/0183422 A1
(43) Pub. Date: Jun. 5, 2025

(54) BATTERY CAN HAVING SUBSTANTIALLY ZERO-RADIUS INTERIOR CORNERS

(71) Applicant: Apple Inc., Cupertino, CA (US)

(72) Inventors: Daeshin Lee, San Jose, CA (US); Ulrich A. Bonne, Sunnyvale, CA (US); Mao Li, Chongqing (CN); Jangwoo Kim, Cupertino, CA (US); Rajesh Kandibanda, Menlo Park, CA (US); Heinrich von Bunau, San Jose, CA (US); Liubin Zhou, Shenzhen (CN); Mark E. Wilcox, Morgan Hill, CA (US); Joshua M. Chien, Portola Valley, CA (US); Manuel Nicholas Franco Henriques, Mountain View, CA (US); Samuel Billand, San Francisco, CA (US)

(73) Assignee: Apple Inc., Cupertino, CA (US)

(21) Appl. No.: 18/933,487

(22) Filed: Oct. 31, 2024

Related U.S. Application Data
(60) Provisional application No. 63/604,795, filed on Nov. 30, 2023.

(51) Int. Cl. H01M 50/102; H01M 50/119; H01M 50/15; H01M 50/174

(52) U.S. Cl. CPC H01M 50/102; H01M 50/119; H01M 50/15; H01M 50/174

(57) ABSTRACT

A battery comprising a cover including a cover main wall and a first cover sidewall extending from the cover main wall at a first substantially perpendicular angle, a base including a base main wall and a first base sidewall extending from the base main wall at a second substantially perpendicular angle, a sidewall structure. A first end of the sidewall structure is coupled against the cover main wall and the first cover sidewall to define a first interior corner therebetween. A second end of the sidewall structure is coupled against the base main wall and the first base sidewall to define a second interior corner therebetween. The first and second interior corners include a substantially zero radius. The cover, the base, the sidewall structure, the first interior corner, and the second interior corner define an interior volume. The battery further comprises a battery cell stack positioned in the interior volume.

### CROSS-REFERENCES TO RELATED APPLICATIONS

This application claims priority under 35 U.S.C. § 119(e) to U.S. Provisional Application Ser. No. 63/604,795, filed Nov. 30, 2023, entitled “BATTERY CAN HAVING SUBSTANTIALLY ZERO-RADIUS INTERIOR CORNERS,” which is incorporated herein by reference in its entirety.

### BACKGROUND OF THE INVENTION

As electronic devices develop in functionality, there is a commensurate demand to decrease the size of the electronic devices. At the same time, there is a demand for the electronic device to maintain a certain level of battery performance. However, the electronic device may be limited by the shape and size of the battery.

### BRIEF SUMMARY OF THE INVENTION

One aspect of the disclosure provides for a battery comprising a cover including a cover main wall and a first cover sidewall extending from the cover main wall at a first substantially perpendicular angle, a base including a base main wall and a first base sidewall extending from the base main wall at a second substantially perpendicular angle, a sidewall structure. A first end of the sidewall structure is coupled against the cover main wall and the first cover sidewall to define a first interior corner therebetween. A second end of the sidewall structure is coupled against the base main wall and the first base sidewall to define a second interior corner therebetween. The first and second interior corners include a substantially zero radius. The cover, the base, the sidewall structure, the first interior corner, and the second interior corner define an interior volume. The battery further comprises a battery cell stack positioned in the interior volume. The substantially zero radius may include a radius of less than 1 mm. All interior corners defined between the cover, the base, and the sidewall structure may include a substantially zero radius. The interior volume may be further defined by all interior corners. The first cover sidewall and the first base sidewall may respectively extend from an edge of the cover main wall and the base main wall. The cover main wall may include a second cover sidewall extending from the cover main wall transverse to the first cover sidewall and the base main wall may include a second base sidewall extending from the base main wall transverse to the first base sidewall. The first and second cover sidewalls may be substantially perpendicular to each other, and the first and second base sidewalls may be substantially perpendicular to each other. The cover main wall may include a cover extension portion extending exterior to the sidewall structure and the base main wall may include a base extension portion extending exterior to the sidewall structure. The cover extension portion may lie substantially along a same plane as the cover main wall and the base extension portion lies substantially along a same plane as the base main wall. The sidewall structure may include a plurality of sidewall components, each of the sidewall components include a first end and a second end. The first ends of the sidewall components may be coupled to each other and the second ends of the sidewall components may be coupled to each other to define the sidewall structure. The first end may define a first slot and may include a first ledge, and the second end defines a second slot and may include a second ledge. The first ledge may be received in the second slot and the second ledge may be received in the first slot. The battery may further comprise an electrical contact extending from the interior volume of the sidewall structure to an exterior of the sidewall structure and a conductive component electrically coupling the battery cell stack to the electrical contact. The battery cell stack may be electrically coupled to the conductive component and the conductive component may include less than two bends along a length of the conductive component.

Another aspect of the disclosure provides for a battery, comprising a cover including a cover main wall and a first cover sidewall extending transversely from the cover main wall, a base including a base main wall and a first base sidewall extending transversely from the base main wall, and a sidewall structure. A first end of the sidewall structure is coupled against the cover main wall and the first cover sidewall to define a first interior corner therebetween. A second end of the sidewall structure is coupled against the base main wall and the first base sidewall to define a second interior corner therebetween. The first and second interior corners include a substantially zero radius. The cover, the base, the sidewall structure, the first interior corner, and the second interior corner define an interior volume. The battery further comprises a battery cell stack positioned in the interior volume. The substantially zero radius may include a radius of less than 1 mm. The first cover sidewall may extend substantially perpendicularly from the cover main wall and the first base sidewall may extend substantially perpendicularly from the base main wall. The cover main wall may include a second cover sidewall extending from the cover main wall transverse to the first cover sidewall and the base main wall may include a second base sidewall extending from the base main wall transverse to the first base sidewall. The sidewall structure may include a plurality of sidewall components, each of the sidewall components include a first end and a second end. The first ends of the sidewall components may be coupled to each other and the second ends of the sidewall components are coupled to each other to define the sidewall structure.

Another aspect of the disclosure provides for a battery, comprising a rigid metallic enclosure characterized by an interior volume, wherein the enclosure comprises, a cover including a cover main wall and a first cover sidewall extending from the cover main wall, a base including a base main wall and a first base sidewall extending from the base main wall, and a structure sidewall extending between the cover and the base to define a plurality of interior corners having a substantially zero radius. The cover is coupled to the structure sidewall at the first cover sidewall and the base is coupled to the structure sidewall at the first base sidewall. The battery further comprises a battery cell stack positioned in the interior volume. The first cover sidewall may extend from the cover main wall at a first substantially perpendicular angle and the first base sidewall may extend from the base main wall at a second substantially perpendicular angle. The substantially zero radius may include a radius of less than 1 mm. All interior corners defined between the cover, the base, and the sidewall structure may include a substantially zero radius. The interior volume may be further defined by all interior corners. The cover main wall may include a second cover sidewall extending from the cover main wall transverse to the first cover sidewall and the base main wall may include a second base sidewall extending from the base main wall transverse to the first base sidewall.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 depicts a partial cross-sectional view of an example battery according to one aspect of the disclosure.

FIG. 2A depicts an isometric view of an example battery according to one aspect of the disclosure.

FIG. 2B depicts an exploded view of the battery of FIG. 2A.

FIG. 2C depicts a partial cross-sectional view of the battery of FIG. 2A along the cross-sectional plane 2C-2C.

FIG. 2D depicts a partial cross-sectional view of the battery of FIG. 2A along the cross-sectional plane 2D-2D.

FIG. 3A depicts an isometric view of an example battery according to one aspect of the disclosure,

FIG. 3B depicts a partial cross-sectional view of the battery of FIG. 3A along the cross-sectional plane 3B-3B.

FIG. 3C depicts a partial cross-sectional view of the battery of FIG. 3A along the cross-sectional plane 3C-3C.

FIG. 4A depicts an isometric view of an example battery according to one aspect of the disclosure,

FIG. 4B depicts a partial cross-sectional view of the battery of FIG. 4A along the cross-sectional plane 4B-4B.

FIG. 4C depicts a partial cross-sectional view of the battery of FIG. 4A along the cross-sectional plane 4C-4C.

FIG. 5A depicts an example sidewall structure according to one aspect of the disclosure.

FIG. 5B depicts a partial view of sidewall components of the sidewall structure of FIG. 5A.

FIG. 6 depicts an example sidewall structure according to one aspect of the disclosure.

FIG. 7A depicts a partial cross-sectional view of an example battery according to one aspect of the disclosure.

FIG. 7B depicts the example battery of FIG. 7A coupled between a base and a cover.

FIG. 8 depicts an example flowchart of forming a battery according to one aspect of the disclosure.

### DETAILED DESCRIPTION OF THE INVENTION

When batteries are coupled in a battery pack or electronic device, the batteries may occupy an effective volume, defined by the volume of the major dimensions of the batteries, within that battery pack or electronic device. However, the particular shape and size of certain features of the battery (e.g., the battery enclosure) may effectively prevent other components (e.g., a battery cell, electrode tab, or other components) from occupying the space within the effective volume. In other words, certain features of the battery may have a shape and/or size that renders certain portions of the effective volume a dead space (e.g., a space that cannot be easily occupied by another component other than the battery). Accordingly, it is desirable to maximize the amount of space that is useable by the battery by minimizing the dead space within this effective volume.

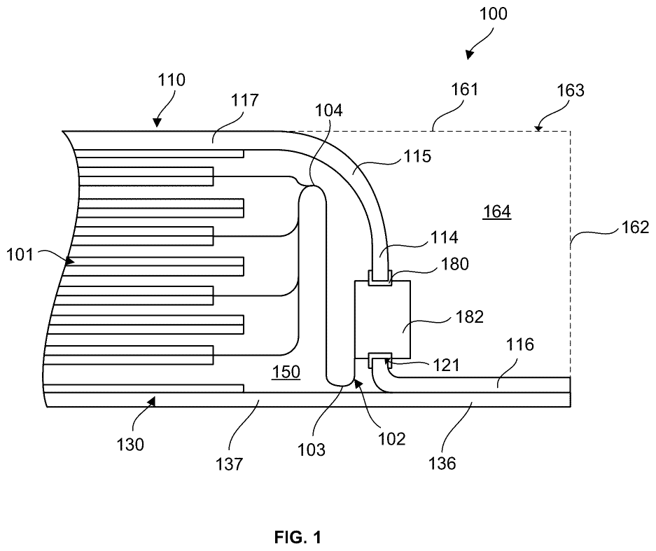

An example of a battery with excessive dead space may be seen in FIG. 1. FIG. 1 depicts a partial cross-sectional view of an example battery 100. The battery 100 may have a cover 110 and a base 130 coupled together via welding, brazing, soldering, gluing, or the like. The cover 110 and the base 130 may have a major dimension (e.g., a major height 162 and a major width 161) that defines the battery 100 to have an effective volume 163. The cover 110 and the base 130 may define an interior volume 150 therebetween. The battery 100 may include a battery cell stack 101 (e.g., one or more of a cathode layer, anode layer, a separator, and current collector) positioned in the interior volume 150. The portion of the effective volume 163 that is not occupied by the internal volume 150 or the battery 100 may be a dead space 164. When the battery 100 is coupled within a battery pack or electronic device, the battery 100 may have a large amount of dead space 164 due to certain features of the battery 100.

For example, the cover 110 may include a cover main wall 117 and a cover sidewall 114 defining a rounded corner 115 therebetween. The corner 115 may have a rounded shape from, for example, the cover 110 being formed from a deep drawn metal stamping process. This rounded shape of the corner 115 may increase the dead space 164 in the effective volume 163 by decreasing the size of the interior volume 150 as well as defining a space just exterior of the corner 115 that is not easily occupied by another component. While the radius of this corner 115 may be decreased in the stamping process by decreasing a radius of the stamp, there is a lower limit on the radius of the corner 115 as having too small of a radius increases the risk that the cover 110 will tear along the corner 115 during the stamping process or during use. As such, the rounded shape of the corner 115 may increase the dead space 164 of the battery 100 within the effective volume 163.

Further, the cover 110 may include a cover extension portion 116 extending from the cover sidewall 114 exterior of the interior volume 150 and the base 130 may include a base extension portion 136 extending past the cover sidewall 114 exterior of the interior volume 150. The cover 110 and the base 130 may be coupled to each other at the cover extension portion 116 and the base extension portion 136. The lengths of the extension portions 116, 136 may correspond to a minimum length required to enable the cover 110 and the base 130 to be sufficiently coupled to each other along the extension portions 116, 136 (e.g., enough length for the extension portions 116, 136 to be seam welded together). However, this length, as well as the height of the combined extension portions 116, 136, may increase the effective volume 163 occupied by the battery 100 while increasing the dead space 164 of the battery 100 within the effective volume 163 because the dimensions of the extension portions 116, 136 create a space within the effective volume 163 that is not easily occupied by other components.

The battery 100 may include an insulating component 180 (e.g., a gasket) and electrical contact 182 (e.g., a rivet) received through an aperture 121 defined along the cover sidewall 114. The battery cell stack 101 may be electrically coupled to the electrical contact 182 through a conductive component 102. The electrical contact 182 and the conductive component 102 may be made of a conductive material (e.g., as aluminum, copper, nickel, or the like) such that an electrical charge may be transferred from the battery cell stack 101 through the conductive component 102 to the electrical contact 182 to provide power to one or more electronic components coupled to the electrical contact 182. The method of coupling the battery cell stack 101 in the interior volume 150 may result in certain component (e.g., the conductive component 102) occupying a large amount of space. In particular, after the cover 110 is formed, and the electrical contact 182 and the insulating component 180 are coupled in the aperture 121, the battery cell stack 101 and the conductive component 102 may be coupled to the electrical contact 182 while the battery cell stack 101 is positioned outside interior volume 150. After the conductive component 102 is coupled to the electrical contact 182, the battery cell stack 101 may be rotated about the coupling point between the conductive component 102 and the electrical contact 182, into the interior volume 150, such that the conductive component 102 defines a first bend 103 and a second bend 104 along the conductive component 102. These bends 103, 104 may occupy space within the interior volume 150 that may otherwise be used by a larger battery cell stack 101. Accordingly, the battery 100 may have a decreased energy density.

The present disclosure is directed to a battery with an enclosure having interior corners that have a substantially zero radius. Specifically, the cover and the base may be coupled to a sidewall structure such that the interior corners of the battery defined between the cover and the sidewall structure, and the base and the sidewall structure may have a substantially zero radius. This configuration minimizes the amount of dead space in the effective volume of the battery by, for example, increasing the interior volume of the battery to store more components (e.g., a larger battery cell), thus increasing the energy density of the battery. This configuration additionally provides a decreased extension portion (or no extension portion at all), which decreases may decrease the dead space within the effective volume of the battery. This configuration may also include a shorter conductive component (e.g., a conductive component with fewer bends), which allows for a larger battery cell stack to be positioned in the interior volume, therefore further increasing the energy density of the battery.

Although the remaining portions of the description will routinely reference lithium-ion battery cells, it will be readily understood by the skilled artisan that the technology is not so limited. The present designs may be employed with any number of battery or energy storage devices, including other rechargeable and primary, or non-rechargeable, cell types, as well as electrochemical capacitors also known as supercapacitors or ultracapacitors, electrolysers, fuel cells, and other electrochemical devices. Moreover, the present technology may be applicable to battery cells and energy storage devices used in any number of technologies that may include, without limitation, phones and mobile devices, handheld electronic devices, wearable devices, laptops and other computers, appliances, heavy machinery, transportation equipment, spacecraft electronics payloads, vehicles, as well as any other device that may use battery cells or benefit from the discussed designs. Accordingly, the disclosure and claims are not to be considered limited to any particular example discussed, but can be utilized broadly with any number of devices that may exhibit some or all of the electrical or chemical characteristics of the discussed examples.

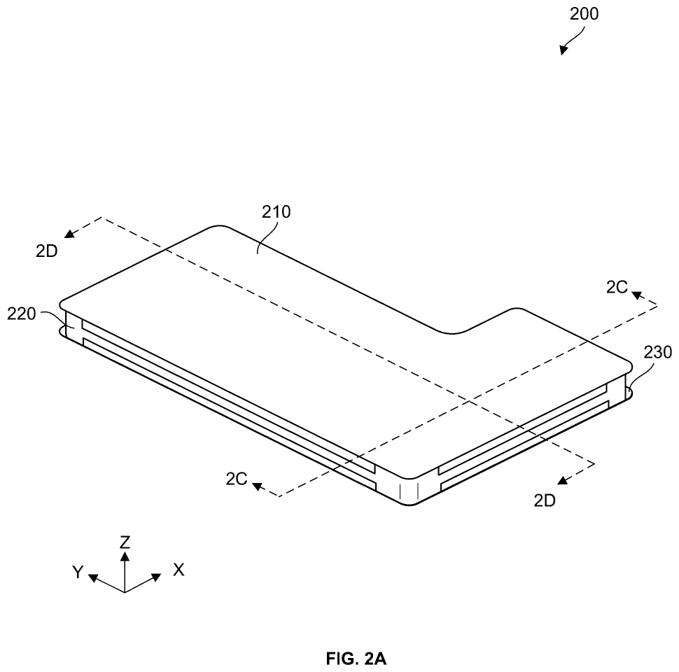

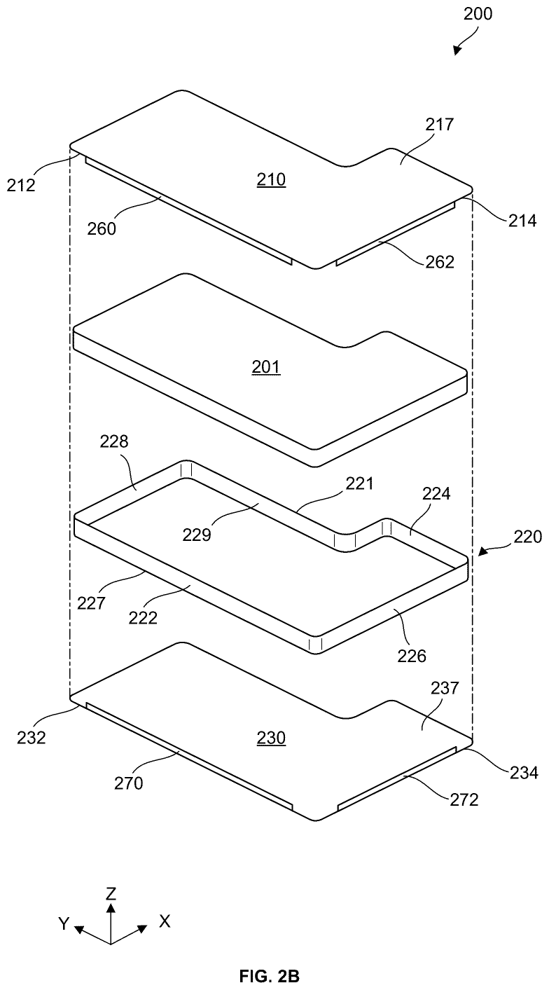

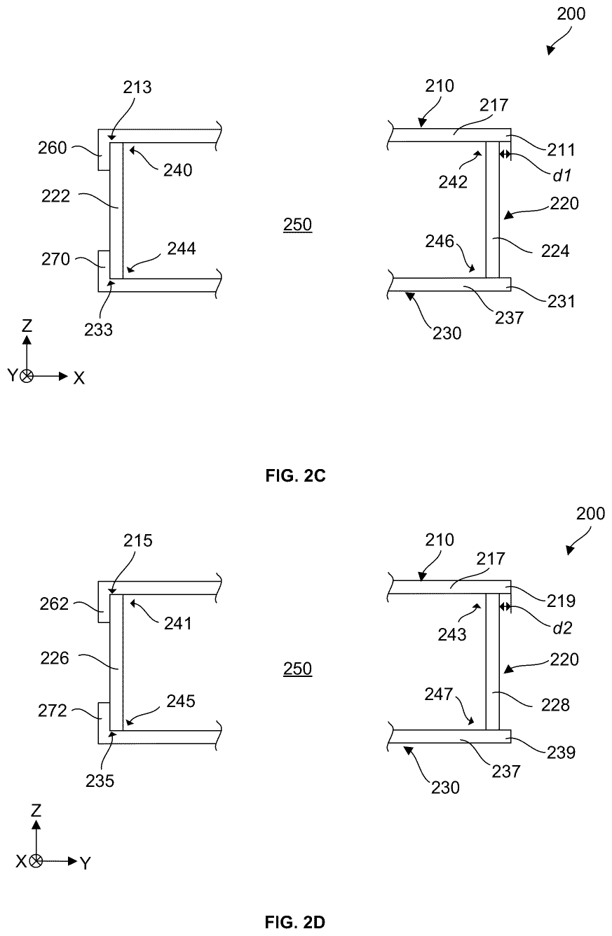

FIGS. 2A-2D depict an example battery 200. It is understood that features ending in like reference numerals as features discussed above are similar, except as noted below. As shown in FIG. 2A, the battery 200 may include a cover 210, a sidewall structure 220, a base 230, and a battery cell stack 201 (e.g., a battery cell stack includes one or more of a layer of cathode active material, anode active material, a separator, and a current collector). The cover 210, sidewall structure 220, and base 230 may form an enclosure for the battery 200. The enclosure may be in the form of a “can” (e.g., thin-walled container), each of which may be made from a metal (e.g., aluminum, aluminum alloy such as 3003 aluminum, stainless steel, steel, or the like) such that the enclosure may be rigid. However, in other embodiments, the enclosure be any other suitable configuration, such as a cylinder, octagon, canister, pouch or the like. The battery cell stack 201 may be positioned within an interior volume of the enclosure (e.g., the interior volume 250).

Turning to FIG. 2B, the cover 210 may include a cover main wall 217, and a first cover sidewall 260 extending transversely from a first cover edge 212 of the cover main wall 217 and a second cover sidewall 262 extending transversely from a second cover edge 214 of the cover main wall 217. The base 230 may include a base main wall 237, and a first base sidewall 270 extending transversely from a first base edge 232 of the base main wall 237 and a second base sidewall 272 extending transversely from a second base edge 234 of the base main wall 237. However, in other embodiments, the cover and base sidewalls may extend from their respective main walls at an intermediate portion of the main walls (e.g., from a portion of the main walls spaced away from the edges of the main walls). The cover 210 may be coupled to a first end 221 of the sidewall structure 220 and the base 230 may be coupled to a second end 227 of the sidewall structure 220 opposite the first end. The sidewall structure 220 may include a first structure sidewall 222, a second structure sidewall 224, a third structure sidewall 226, a fourth structure sidewall 228, and a fifth structure sidewall 229 that, collectively, forms the shape of the sidewall structure 220. The cover sidewall 260 and the first base sidewall 270 may be coupled to the first structure sidewall 222, and the second cover sidewall 262 and the second base sidewall 272 may be coupled to the second structure sidewall 224. The cover 210 and the base 230 may be coupled to the sidewall structure 220 through welding, brazing, soldering, gluing, or the like. In particular, the cover 210 and the base 230 may be coupled to the sidewall structure 220 through a laser weld to provide a lap weld, edge weld, line weld, seam line weld, or the like.

The main walls 217, 237 and the sidewall structure 220 may define a plurality of interior corners. For example, turning to FIG. 2C, the cover main wall 217 and the first structure sidewall 222 may be coupled together to define a first interior corner 240 therebetween, the cover main wall 217 and the second structure sidewall 224 may be coupled together to define a second interior corner 242 therebetween, the base main wall 237 and the first structure sidewall 222 may be coupled together to define a third interior corner 244 therebetween, the base main wall 237 and the second structure sidewall 224 may be coupled together to define a fourth interior corner 246 therebetween. Turning to FIG. 2D, the cover main wall 217 and the third structure sidewall 226 may be coupled together to define a fifth interior corner 241 therebetween, the cover main wall 217 and the fourth structure sidewall 228 may be coupled together to define a sixth interior corner 243 therebetween, the base main wall 237 and the third structure sidewall 226 may be coupled together to define a seventh interior corner 245 therebetween, the base main wall 237 and the fourth structure sidewall 228 may be coupled together to define an eight interior corner 247 therebetween. The cover main wall 217, the base main wall 237, the sidewall structure 220, and the interior corners 240, 241, 242, 243, 244, 245, 246, 247 collectively define the interior volume 250 for storing electronic components within the battery 200 (e.g., the battery cell stack 201).

The interior corners 240, 241, 242, 243, 244, 245, 246, 247 may additionally or alternatively include corners between two components that are coupled to each other where the planes of the surfaces of only those two components intersect rather than the planes of the surfaces of three components intersect. For example, the interior corners 240, 241, 242, 243, 244, 245, 246, 247 may be the respective corners where only the X-Y plane of the cover 210 and base 230, and the Y-Z and Y-X planes of the sidewall structure 220 intersect, rather than the respective corners where multiple planes of the sidewall structure 220, and the plane of the cover 210 or the base 230 intersect. Examples of the latter corners may be three-sided corners defined between two of the structure sidewalls 222, 224, 226, 228, 229, and either the cover 210 or the base 230. As such, the interior corners 240, 241, 242, 243, 244, 245, 246, 247 may have a substantially zero radius while the three-sided corners may not. However, in some embodiments, the three-sided corners may also include a substantially zero radius such that all the corners defining the interior volume have a substantially zero radius. The interior corners 240, 241, 242, 243, 244, 245, 246, 247 may also include corners defined by the intersection of two planes of the interior-most surfaces of the cover 210 and the sidewall structure 220, and the base 230 and the sidewall structure 220. For example, the interior corners 240, 241, 242, 243, 244, 245, 246, 247 may include the respective corners of the intersection defined between the X-Y plane of the interior-most surfaces of the cover 210 and the base 230, and the Y-Z and Y-X planes of the interior-most surfaces of the sidewall structure 220.

As discussed above, a rounded corner may increase the dead space in the effective volume of a battery enclosure. Accordingly, forming a battery enclosure with a smaller radius may reduce this dead space by increasing the amount space that can be used within an interior volume of a battery enclosure. The battery 200 provides this benefit by providing for interior corners 240, 241, 242, 243, 244, 245, 246, 247 that have a substantially zero radius. In other words, the interior corners 240, 241, 242, 243, 244, 245, 246, 247 may have a radius of less than about 1 mm, such as less than about 0.75 mm, such as less than about 0.5 mm, such as less than about 0.25 mm, or having a completely zero radius. Because the interior volume 250 does not include rounded corners, the interior volume 250 may be larger than an interior volume of conventional batteries of a similar effective volume (e.g., the volume 150 of the battery 100), which allows for more components to be housed within the interior volume 250, such as a larger battery cell stack 201. Accordingly, the substantially zero radius of the interior corners 240, 241, 242, 243, 244, 245, 246, 247 may, compared to other conventional batteries, decrease the dead space within the effective volume of the battery 200 and increase the energy density of the battery 200.

The decreased dead space within the effective volume from the substantially zero radius of the interior corners 240, 241, 242, 243, 244, 245, 246, 247 may be further shown when the structure sidewalls 222, 224, 226, 228 are substantially planar, the cover main wall 217 and the structure sidewalls 222, 224, 226, 228 are substantially perpendicular to each other, and the base main wall 237 and the structure sidewalls 222, 224, 226, 228 are substantially perpendicular to each other. In other words, when the interior corners 240, 241, 242, 243, 244, 245, 246, 247 are a substantially perpendicular angle and the structure sidewalls 222, 224, 226, 228 are substantially planar. Substantially perpendicular may mean that the angle of the interior corners 240, 241, 242, 243, 244, 245, 246, 247 may be between about 75° and 105°, such as between about 80° and 100°, such as between about 85° and 95°, or about 90°. The interior corners 240, 241, 242, 243, 244, 245, 246, 247 may have a substantially zero radius when the interior corners 240, 241, 242, 243, 244, 245, 246, 247 have a substantially perpendicular angle. The interior corner defined between the cover 210 and the fifth structure sidewall 229, and the cover 210 and the fifth structure sidewall 229 may also have a substantially zero radius as described above. Substantially planar may mean that the structure sidewalls 222, 224, 226, 228 have less than about 0.06 rad/m, such as less than about 0.03 rad/m, such as less than about 0.02 rad/m, or about completely planar.

In this configuration, the interior volume 250 may define a substantially rectangular cross-sectional shape. Where the structure sidewalls have a non-planar shape and/or the interior corners are not a substantially perpendicular angle, the enclosure may have protruding features with a shape and size that prevents other components from being occupied within the effective volume of the battery (i.e., increasing the dead space within the effective volume), which may decrease the energy density of the battery. The substantially perpendicular angle of the interior corners 240, 241, 242, 243, 244, 245, 246, 247 and substantially planar structure sidewalls 222, 224, 226, 228 addresses this issue by maximizing the usable space within the effective volume. However, in other embodiments, the interior corners may have any other angle (e.g., greater or less than substantially perpendicular) and the structure sidewalls may have any other shape (e.g., curved, angled, irregular shapes, or the like).

The cover sidewalls 260, 262 and base sidewalls 270, 272 may lie flush against the structure sidewalls 222, 224, 226, 228 in an assembled configuration. For example, where the cover sidewalls 260, 262 and base sidewalls 270, 272 and the structure sidewalls 222, 224, 226, 228 have a similar shape (e.g., both being substantially planar), and the cover sidewalls 260, 262 and base sidewalls 270, 272 respectively extend from the cover main wall 217 and the base main wall 237 at an angle such that substantially all of the sidewalls 260, 262 and base sidewalls 270, 272 contacts the structure sidewalls 222, 224, 226, 228, the cover sidewalls 260, 262 and base sidewalls 270, 272 may lie flush against the structure sidewalls 222, 224, 226, 228. In this configuration, the cover sidewalls 260, 262 and base sidewalls 270, 272 may decrease the effective volume of the battery 200 without affecting the amount of dead space within the effective volume, thus decreasing the ratio of dead space within the effective volume of the battery 200. Further, this configuration may allow for the coupling between cover sidewalls 260, 262 and base sidewalls, and the structure sidewalls 222, 224, 226, 228 to be stronger.

The cover sidewalls 260, 262 may be transverse to each other and the base sidewalls 270, 272 may be transverse to each other. For example, the cover sidewalls 260, 262 may be substantially perpendicular to each other and the base sidewalls 270, 272 may be substantially perpendicular to each other. In particular, the angle between the cover sidewalls 260, 262 and the angle defined between the base sidewalls 270, 272 may correspond to the angle between the particular structural sidewalls that the cover sidewalls 260, 262 and the base sidewalls 270, 272 are going to couple to (e.g., the first structural sidewall 222 and the third structural sidewall 226). This configuration may be useful in respectively aligning the cover 210 and the base 230 to the sidewall structure 220 when coupling the cover 210 and the base 230 to the sidewall structure 220. As will be discussed further below, this alignment may be achieved by respectively moving the cover 210 and base 230, and the sidewall structure 220 to each other until the sidewall structure 220 abuts against both the cover sidewalls 260, 262 and until the sidewall structure 220 abuts against both the base sidewalls 270, 272. In this manner, the cover 210 and the base 230 may be positioned in a specific orientation and position relative to the sidewall structure 220. However, in other embodiments, the angle between the cover and base sidewalls may not correspond to the angle between the corresponding structural sidewalls that the cover and base sidewalls are going to be coupled to, and may include other angles (e.g., angles larger or greater than the angle between the corresponding structural sidewalls).

Although the cover sidewalls 260, 262 and the base sidewalls 270, 272 are depicted as extending from the main walls 217, 237 at an equal angle from each other, in other embodiments, one or more of the sidewalls can extend from their respective main walls at a different angle from one or more of the other sidewalls. For example, the first cover sidewall can extend from the cover main wall at a greater angle than the second cover sidewall extends from the cover main wall, the first base sidewall can extend from the base main wall at a greater angle than the second base sidewall extends from the base main wall, the first cover sidewall can extend from the cover main wall at a greater angle than the first base sidewall extends from the base main wall, or the like.

Although the cover 210 and the base 230 each include two sidewalls 260, 262, 270, 272, in other embodiments, each of the cover and base may include more or less than two sidewalls respectively extending therefrom, such as one, three, four, or the like. For example, at least one of the cover and base may include a sidewall extending from each edge of the cover and base. Where there are multiple sidewalls extending from one or more edges of the base and cover, the sidewalls on each edge may be spaced apart (e.g., having a gap there between) or continuous with each other. Further, although the cover 210 and the base 230 includes one sidewall 260, 262, 270, 272 respectively extending from the edges 212, 214, 232, 234, in other embodiments, there may be more than one sidewall extending from one or more of these edges, such as two sidewalls, three sidewalls, four sidewalls, or the like. In a yet further embodiment, the cover and the base may not have an equal amount of sidewalls and, instead, may each have a different number of sidewalls.

The cover main wall 217 may include a first cover extension portion 211 extending exterior to the second structure sidewall 224 in an X-direction a first distance d1. The base main wall 237 may include a first base extension portion 231 extending exterior the second structure sidewall 224 in an X-direction the first distance d1. The cover main wall 217 may include a second cover extension portion 219 extending exterior the fourth structure sidewall 228 in a Y-direction a distance d2. The base main wall 237 may include a second base extension portion 239 extending exterior the fourth structure sidewall 228 in a Y-direction the distance d2.

The extension portions 211, 219, 231, 239 may allow for the cover 210 and the base 230 to be respectively coupled to the second structure wall 224 and the fourth structure wall 228 more easily. Specifically, when welding the cover 210 and the base 230 to the sidewall structure 220, the extension portions 211, 219, 231, 239 may allow for the weld to be positioned slightly exterior to the second structure sidewall 224 (e.g., in an X-direction) and the fourth structure sidewall 228 (e.g., in a Y-direction). In this manner, the cover 210 and the base 230 can be welded to the sidewall structure 220 without requiring the weld to be positioned directly along the centerline of the second structure sidewall 224 and the fourth structure sidewall 228. Accordingly, the extension portions 211, 219, 231, 239 may allow for the cover 210 and the base 230 to be respectively coupled to the second structure wall 224 and the fourth structure wall 228 with a greater margin for error. Additionally, the extension portions 211, 219, 231, 239 may allow for a greater margin of error when forming the cover 210 and the base 230 so that the dimensions of the cover 210 and the base 230 do not need to precisely line up with the edges of the sidewall structure 220.

The distances d1, d2 may be smaller than the distances of corresponding features of conventional batteries (e.g., than extension portions 116, 136 of the battery 100). This smaller distance may decrease the dead space of the effective volume of the battery 200, thus allow for a larger interior volume 250 within the effective volume of the battery 200 to store more components (e.g., a larger battery cell stack). At the same time, the distances d1, d2 allow for the cover 210 to have sufficient material extending past the sidewall structure 220 to allow the cover 210 to be coupled (e.g., welded) to the sidewall structure 220. The substantially zero radius of the interior corners 240, 241, 242, 243, 244, 245, 246, 247 and the decreased distance d1, d2 of the extension portions 211, 219, 231, 239 may provide a 2.5% volume increase. This may be particularly significant where volume increases of 0.1% to 0.2% may be considered meaningful.

The extension portions 211, 219, 231, 239 may extend on substantially the same plane as the respective cover main wall 217 and the base main wall 237. For example, the extension portions 211, 219, 231, 239 may extend from the respective cover main wall 217 and the base main wall 237 at a respective angle of less than or about 20° relative to each other, such as less than or about 10°, such as less than or about 5°, or being completely planar with each other.

Although the extension portions 211, 219 are depicted as extending past the second structure sidewall 224 a same distance d1 and the extension portions 231, 239 are depicted as extending past the fourth structure sidewall 228 a same distance d2, in other embodiments, the extension portions may extend past the corresponding structure sidewalls at different lengths. In yet other embodiments, one or more of the cover and base may not include an extension portion. In this example, the edges of the cover and base may be substantially flush with an exterior surface of the corresponding structure sidewalls.

The battery cell stack 201 may be any suitable type of rechargeable battery including but not limited to: dry-cell, wet-cell, NiCd (Nickel-Cadmium), NiMH (Nickel-Metal Hydride), Li-ion (Lithium Ion), Nickel-Zinc (NiZn), Lithium-Ion Polymer (LiPo), lithium iron phosphate battery (LiFePO) or lead-acid. In some embodiments, the battery cell stacks 201 may have any suitable geometry including, but not limited to, prismatic cells (e.g., cuboid), vertical stacked cells, cylindrical cells, or the like. In some embodiments, the battery cell stacks 201 may be connected together within the battery 200 to provide a “high” voltage that may be suitable for powering main traction motors for an electric vehicle or providing power to other electronic devices. The battery 200 may have a voltage range between 20 V and 600 V, between 200 V and 500 V, or between 300 V and 450 V. In some embodiments, one or more of the battery cell stacks 201 may be connected together to form a “low” voltage battery 200 (e.g., that may be integrated with a high voltage battery 200 or may be separate) that may be suitable for powering auxiliary systems. The low voltage battery 200 may have a voltage range between 2 V and 5 V, 10 V and 19 V, between 11 V and 15 V, or approximately 12 V.

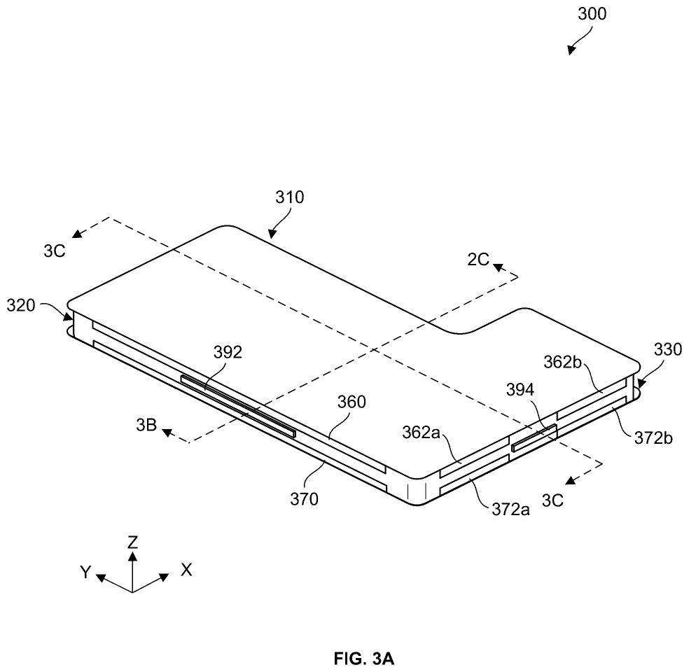

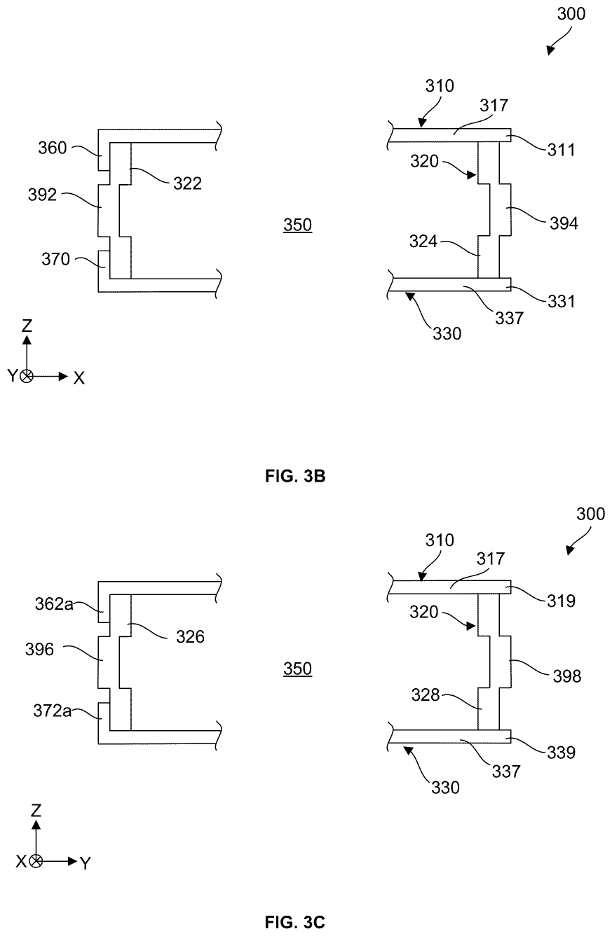

In some embodiments, the sidewall structure may not have a rectangular cross-sectional shape. Instead, the sidewall structure may have an irregular shape. For example. FIGS. 3A-3C depict an example battery 300. It is understood that features ending in like reference numerals as features discussed above are similar, except as noted below. The sidewall structure 220 may include a first embossment 392 extending from the first structure sidewall 322 along an X-axis, a second embossment 394 extending from the second structure sidewall 324 along an X-axis, a third embossment 396 extending from the third structure sidewall 326 along a Y-axis, and a fourth embossment 398 extending from the fourth structure sidewall 328 along a Y-axis. The embossments 392, 394, 396, 398 may improve the distribution of shear stress to the structure sidewalls 322, 324, 326, 328. Additionally, the embossments 392, 394, 396, 398 may increase the interior volume 350.

The first embossment 392 may be positioned along the Z-axis between the first cover sidewall 360 and the first base sidewall 370. The second third embossment 396 may be positioned along the Z-axis between the first cover sidewall 362a and second sidewall 362b, and the first base sidewall 372a and second base sidewall 372b. Although the first embossment 392 and third embossment 396 are depicted as respectively being positioned equidistant from each of the sidewalls 360, 370, 362a, 362b, 372a, 372b, in other embodiments, the embossments may be closer or further from one sidewall to another. In other embodiments, there may be more than one embossment per structure sidewall, just as two, three, four, or the like. Although the embossments 392, 394 are depicted as having a length less than a length of the corresponding structure sidewalls 322, 324, in other embodiments, the embossments may have any length with respect to their corresponding sidewall, including extending the entire length of the structure sidewall. In a yet further embodiment, the embossments may have any cross-sectional shape, such as having a curved shape, an irregular shape, or the like.

In some embodiments, the embossments 392, 394, 396, 398 may extend from the structure sidewalls 322, 324, 326, 328 a distance such that the exterior surfaces of the embossments 392, 394, 396, 398 are substantially flush with the exterior surfaces of the sidewalls 360, 362a, 362b, 370, 372a, 372b and the extension portions 311, 319, 331, 339. In this manner, the embossments 392, 394, 396, 398 may increase the structural support provided to the battery 300 while minimizing the dead space occupied by the battery 300. In another embodiment, the embossment may have a size and shape to correspond to the distance between each of the sidewalls. In this manner, the embossment may provide even more structural support to the battery while minimizing the dead space of the battery. In other embodiments, one or more of the embossments can have a height along the Z-axis greater than a distance between adjacent cover and base sidewalls. For example, if a structure sidewall has multiple cover sidewalls and base sidewalls, an embossment may be positioned between the sidewalls and have a greater height than the distance between the cover sidewalls and the base sidewalls.

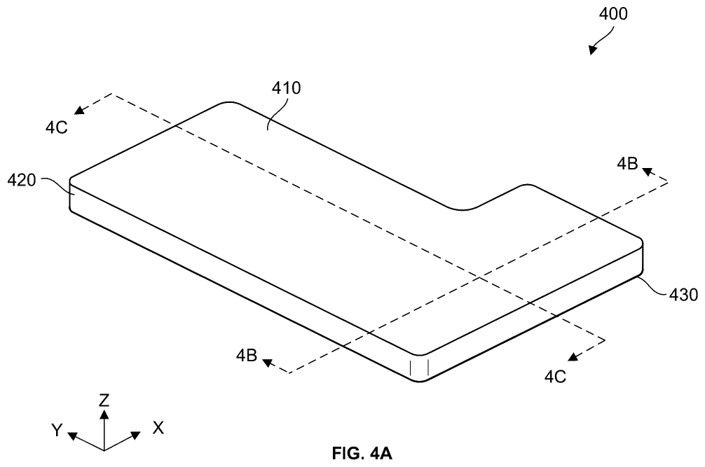

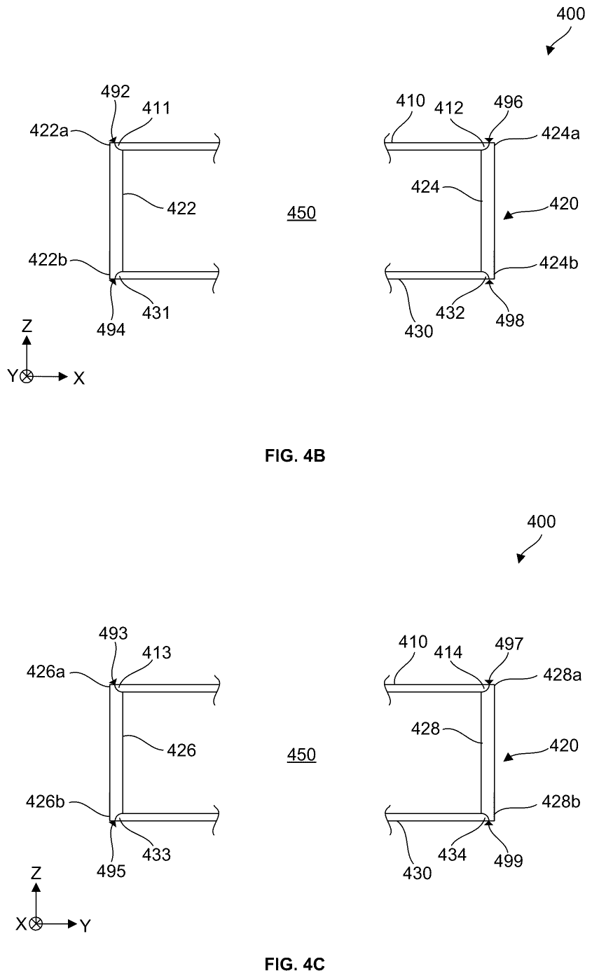

In some embodiments, the sidewall structure may not include any extension portions. For example. FIGS. 4A-4C depict an example battery 400. It is understood that features ending in like reference numerals as features discussed above are similar, except as noted below. The sidewall structure 420 defines recesses at each end of the structure sidewalls 422, 424, 426, 428 to receive the cover 410 and the base 420. Specifically, the first structure sidewall 422 defines a first recess 492 at a first top end 422a and a second recess 494 at a first bottom end 422b, the second structure sidewall 424 defines a third recess 496 at a second top end 424a and a fourth recess 498 at a second bottom end 424b, the third structure sidewall 426 defines a fifth recess 493 at a third top end 426a and a sixth recess 495 at a third bottom end 426b, and the fourth structure sidewall 428 defines a seventh recess 497 at a fourth top end 428a and an eight recess 499 at a fourth bottom end 428b. Although the recesses 492, 492, 494, 495, 496, 497, 498, 499 are depicted as having an arcuate cross-sectional shape, in other embodiment, the recess may have any other shape, such as rectangular, linear, step-wise, irregular, or the like.

The ends of the cover 410 and the base 430 may be received in the recesses 492, 492, 494, 495, 496, 497, 498, 499. For example, the cover 410 may include a first cover end 411 received in the first recess 492, a second cover end 412 received in the third recess 496, a third cover end 413 received in the fifth recess 493, and a fourth cover end 414 received in the seventh recess 497. The base 430 may include a first base end 431 received in the second recess 494, a second base end 432 received in the fourth recess 498, a third base end 433 received in the sixth recess 495, and a fourth base end 434 received in the eight recess 499. As the example battery 400 does not include any extension portions, the ratio of dead space in the effective volume of the 400 may be decreased as more of the effective volume is usable for, e.g., storing a larger electrode within the interior volume 450.

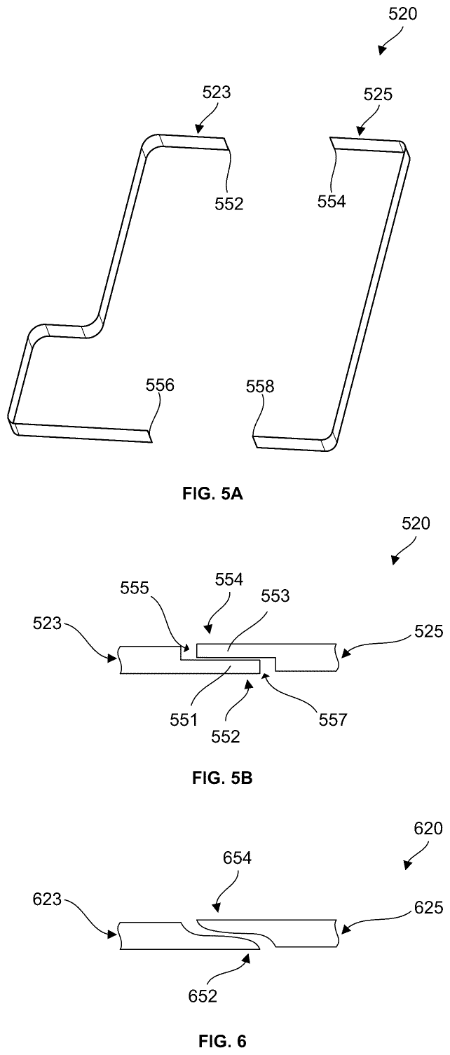

In some embodiments, the sidewall structure may be made of more than one piece. For example, FIGS. 5A and 5B depict an example sidewall structure 520. It is understood that features ending in like reference numerals as features discussed above are similar, except as noted below. The sidewall structure 520 may include a first sidewall component 523 and a second sidewall component 525. The first sidewall component 523 may include a first end 552 and a second end 556. The second sidewall component 525 may include a first end 554 and a second end 558. The sidewall components 523, 525 may couple to each other at the respective first ends 552, 554 and second ends 556, 558. In particular, the first ends 552, 554 and the second ends 556, 558 may be shaped to be at least partially received in each other before being coupled together (e.g., welding, brazing, soldering, gluing, or the like). Although two sidewall components 523, 525 are depicted, in other embodiments, there may be more than two sidewall components, such as three, four, five, or the like.

For example, FIG. 5B depicts the first ends 552, 554 being coupled to each other. It is understood that the second ends 556, 558 include a similar structure to the first ends 552, 554. The first end 552 may include a first ledge 551 and may define a first slot 555. The second end 554 may include a second ledge 553 and may define a second slot 557. The slots 555, 557 may be sized and shaped to receive a corresponding ledge 551, 553. For example, the first slot 555 may be sized and shaped to receive the second ledge 553, and the second slot 557 may be sized and shaped to receive the first ledge 551. In this configuration, the interior and exterior surfaces of the ends 552, 554 are substantially aligned. When the ledges 551, 553 are received in the slots 555, 557, the ends 552, 554 may be coupled to each other (e.g., welded) through the ledges 551, 553. In other embodiments, the ends may be coupled together through different configurations. For example, one of the ends may include one or more prongs that define one or more slots therebetween and the other end may include one or more ledges sized and shaped to be received in those slots. In yet other embodiments, other configurations are envisioned.

In other embodiments, the ends may not be rectangular and, instead, may have any other shape. For example, the ends may have irregular shapes, such as a singular line, a jagged edge, or the like. FIG. 6 depicts the ends 652, 654 of the sidewall structure 620. It is understood that features ending in like reference numerals as features discussed above are similar, except as noted below. As shown, the ends 652, 654 may each include a curvilinear shape that corresponds with each other. This shape may be beneficial to minimize the gap between the ends 652, 654 when mating the ends 652, 654 together to enable a stronger coupling (e.g., a stronger weld) between the ends 652, 654.

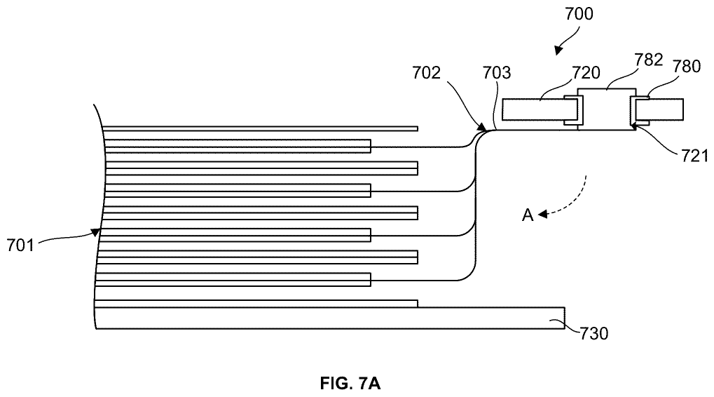

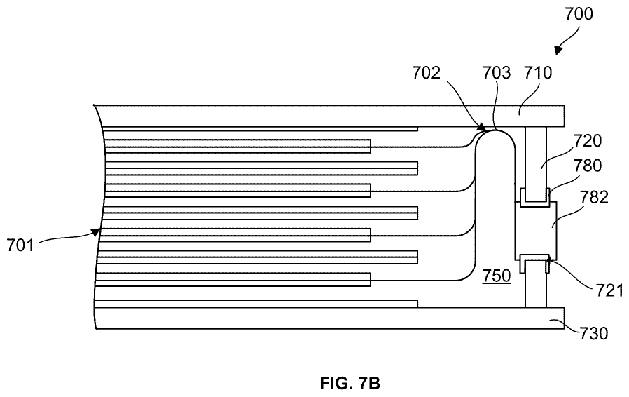

As will be described further below, the method of forming the battery of the present disclosure may allow for a larger battery cell to be positioned in the battery of the present disclosure. FIGS. 7A and 7B depict a partial cross-sectional view of an example battery 700. It is understood that features ending in like reference numerals as features discussed above are similar, except as noted below. FIG. 7A depicts the process of coupling the sidewall structure 720 to the base 730 such that the conductive component 702 defines only one bend 703, as will be described further below. FIG. 7B depicts the battery 700 after the sidewall structure 720 is coupled to the cover 710 and the base 730. Turning specifically to FIG. 7B, the battery 700 may include an insulating component 780 and electrical contact 782 received through an aperture 721 defined along the sidewall structure 720 such that the insulating component 780 and electrical contact 782 extends from the interior volume 750 to an exterior of the sidewall structure 720. The battery cell stack 701 may be electrically coupled to the electrical contact 782 through a conductive component 702. The conductive component 702 may be electrically coupled to the electrode tabs of each current collector of the battery cell stack 701. In some embodiments, the conductive component 702 may be a singular monolithic component that collects all the current from the electrode tabs of the battery cell stack 701. The electrical contact 782 and the conductive component 702 may be made of a conductive material (e.g., aluminum, copper, nickel, or the like) such that an electrical charge may be transferred from the battery cell stack 701 through the conductive component 702 to the electrical contact 782 to provide power to one or more electronic components coupled to the electrical contact 782. Although the battery cell stack 701 is depicted as including multiple current collectors coupled to the conductive component 702, in other embodiments, the battery cell stack may only include a single current collector (e.g., a top current collector adjacent the cover) coupled to the conductive component. Multiple current collectors may be beneficial to provide more power within the interior volume 750.

As noted above, in conventional batteries, the conductive component may occupy space within the interior volume that may otherwise be occupied by the battery cell stack (e.g., the conductive component 102). The configuration of this conventional battery may have resulted from forming the cover with a stamping process that forms both the cover main wall and the cover sidewall together. In this conventional configuration, the battery cell stack may be electrically coupled to the electrical component (e.g., a rivet) outside of the cover and then flipped into the cover before coupling the base and the cover together. Such an assembly may cause components that are not the battery cell stack to occupy an unnecessary amount of space within the interior volume of the battery (e.g., the bend 103 of the conductive component 102).

The battery 700 addresses these issues by providing a shorter conductive component 702. In particular, the conductive component 702 may include less than two bends along its length. For example, the conductive component 702 may include only one bend 703 rather than multiple bends (e.g., the bends 103, 104 of the conductive component 102). As there is only one bend 703 along the electrical component 702, more space within the interior volume 750 can be occupied by the battery cell stack 701. Accordingly, the battery 700 may have an increased energy density than conventional batteries, such as the battery 100.

In some embodiments, the electrical contact 782 may be a rivet. The conductive component 702 may be a current collector or a part of a current collector made of an electrically conductive material. The insulating component 780 may include an electrically insulative material, such as rubber, plastic (e.g., polybutylene (PB), perfluoroalkoxy (PFA), polypropylene, and/or polybutylene succinate (PBS)), or the like. In this manner, the insulating component 780 may insulate the sidewall structure from an electrical charge from the electrical contact 782. The electrical component.

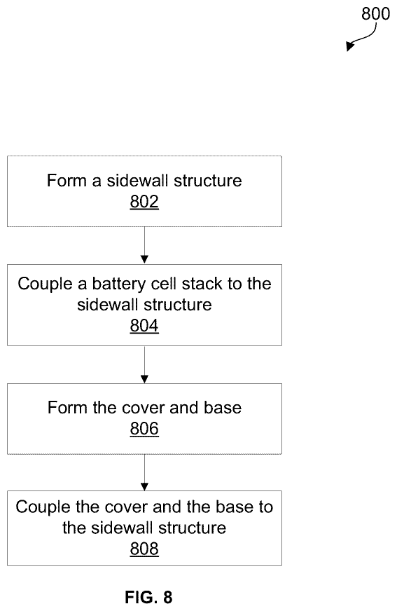

FIG. 8 depicts an example flowchart 800 of forming a battery. It is understood that features ending in like reference numerals as features discussed above are similar, except as noted below. Beginning at Step 802, the sidewall structure may be formed. Where the sidewall structure is a monolithic piece, a blank may be stamped to form a stamped component. For example, turning to FIG. 1, the stamped component may be similar to the cover 110. To form the sidewall structure (e.g., the sidewall structure 220) from the cover 110, the cover main wall 117 and rounded corner 115 may be cut off (e.g., using a rotary cutter, laser, or the like) to form one edge of the sidewall structure (e.g., a first end 221 of the sidewall structure 220). The cover extension portion 116 may then be cut off to form the opposite edge of the sidewall structure (e.g., a second end 227 of the sidewall structure 220). Either of the cover extension portion 116, or the cover main wall 117 and rounded corner 115 may be cut off in any order. After these components are cut off, an aperture (e.g., the aperture 621) may be cut into the sidewall structure to form the sidewall structure 220.

In some embodiments, an embossment may be formed into the sidewall structure. For example, turning to FIGS. 3A-3C, embossments 392, 394, 396, 398 may be formed (e.g., stamped, machined, or the like) into the structure sidewalls 322, 324, 326, 328. However, in other embodiments, the embossments may be formed into the sidewall structure though other means, such as cutting an opening in the sidewall structure and coupling (e.g., welding, brazing, solder, or the like), the embossment onto the sidewall structure. In other embodiments, recesses may be formed in the top and bottom ends of the sidewall structure. For example, turning to FIGS. 4A-4C, recesses 492, 492, 494, 495, 496, 497, 498, 499 may be formed (e.g., through machining or the like) in the sidewall structure.

In another embodiment, turning to FIGS. 5A and 5B, the sidewall structure 520 may be formed from a plurality of components. Specifically, a plurality of blanks may be cut having a desired height for the sidewall structure. Before each of the blanks are bent to form the sidewall component 523, 525, each end 552, 554, 556, 558 of the blanks may be machined or otherwise cut to form ledges 551, 553 and define slots 555, 557. Each of these blanks may then be bent to a desired shape to form sidewall components 523, 525. In other embodiments, the ends may be machined after the blanks are bent. In some embodiments, an aperture (e.g., the aperture 721) may be drilled along one or more of the blanks. Once the sidewall components 523, 525 are formed, the first ends 552, 554 and the second ends 556, 558 may be respectively coupled to each other. For example, turning to the first ends 552, 554, the first ledge 551 may be received in the second slot 557 and the second ledge 55 may be received in the first slot 555. The first ends 552, 554 may then be coupled to each other by coupling (e.g., welding) the overlapping ledges 551, 553 together. A similar process may then be performed for the second ends 556, 558. The sidewall structure 520 may be formed once the first ends 552, 554 and the second ends 556, 558 are respectively coupled to each other. A similar process may be used for the structure sidewall 620.

Turning to Step 804, a battery cell stack may be coupled to the sidewall structure. Specifically, a battery cell stack may be coupled to the sidewall structure 520 before the sidewall components 523, 525 (or sidewall components 623, 625 of the sidewall structure 620) are coupled together. For example, turning to FIG. 7A, an insulating component 780 and an electrical contact 782 may be coupled through the aperture 721. Before the sidewall components are fully coupled together to form the sidewall structure 720 (or after only one of the ends of the sidewall component are coupled together), the battery cell stack 701 may be positioned between the sidewall components. The battery cell stack 701 may be electrically coupled to the electrical contact 782 by coupling the conductive component 702 to the electrical contact 782. After the conductive component 702 is coupled to the electrical contact 782, the portion of the sidewall structure 720 including the electrical contact 782 is rotated in the direction of the arrow A. The sidewall structure 720 may then be formed by coupling the other set of ends of the sidewall components together. As the battery cell stack 701 is already positioned between the sidewall components before the cover 710 and the base 730 are coupled to the sidewall structure 720, the electrical contact 782 may define only one bend 703 to electrically couple the battery cell stack 701 to the electrical contact 782. The battery cell stack 701 does not need to be both rotated relative to the electrical 782 and flipped into position as in conventional battery designs (e.g., the battery cell stack 101 in the sidewall structure 120). In this manner, the conductive component 702 may include only one bend 703 along its length rather than more bends (e.g., as in the conductive component 102), thus allowing for a larger battery cell stack 701 to be positioned in the interior volume 750, thereby increasing the energy density of the battery 700. The battery cell stack 701 may be electrically coupled to the electrical contact 782 prior to being positioned on the base 730 (e.g., before the base 730 is formed, as described below). However, in other embodiments, the base 730 may already be formed and the battery cell stack 701 may be electrically coupled to the electrical contact 782 as described above after the base 730 is formed (e.g., while the battery cell stack 701 is on the base 730).

Turning to Step 806, the cover and the base may be formed. Turning back to FIGS. 2A-2D, a first blank may be cut to include the cover main wall 217 with the first cover sidewall 260 and the second cover sidewall 262 extending therefrom. A second blank may be cut to include the base main wall 237 with the first base sidewall 270 and the second base sidewall 272 extending therefrom. The cover sidewalls 260, 262 may be bent relative to the cover main wall 217 to a desired angle (e.g., at a substantially perpendicular angle) to form the cover 210. The base sidewalls 270, 272 may be bent relative to the base main wall 237 to a desired angle (e.g., at a substantially perpendicular angle) to form the base 230. The cover and base may be formed simultaneously, or with one in sequence after the other.

Turning to Step 808, the cover and base may be coupled to the sidewall structure. The cover 210 and the base 230 may be aligned with the sidewall structure 220. Specifically, the cover 210 may be moved relative to the sidewall structure 220 until the first cover sidewall 260 abuts against the first structure sidewall 222 and the second cover sidewall 262 abuts against the third structure sidewall 226. The base 230 may also be moved relative to the sidewall structure 220 until the first base sidewall 270 abuts against the first structure sidewall 222 and the second base sidewall 272 abuts against the third structure sidewall 226. Once the cover 210 and the base 230 are aligned to the sidewall structure 220, the cover 210 and the base 230 may be coupled to the sidewall structure 220. For example, one or more welds may be applied through the first cover sidewall 260 and the first structure sidewall 222, the first base sidewall 270 and the first structure sidewall 222, the second cover sidewall 262 and the third structure sidewall 226, and the second cover sidewall 272 and the third structure sidewall 226. Another set of welds may be applied through the cover 210 and the base 230 to the edges of the sidewall structure 220. For example, a weld may be applied through the first cover extension portion 211 and the second structure sidewall 224, the first base extension portion 231 and the second structure sidewall 224, the second cover extension portion 219 and the fourth structure sidewall 228, and the second base extension portion 239 and the fourth structure sidewall 228. Additional welds may be applied between the sidewall structure 220, and the cover 210 and the base 230. In other embodiments, either of the cover or the base may be coupled to the sidewall structure before the other, rather than both the cover and the base being coupled to the sidewall structure simultaneously. The battery 200 may be formed once the cover 210 and the base 230 are coupled to the sidewall structure 220.

In other embodiments, turning to FIGS. 4A-4C, ends of the cover 410 and the base 430 may be coupled to the sidewall structure 420. For example, the cover ends 411, 412, 413, 414 of the cover 410 may be received in the recesses 492, 493, 496, 497 and the base ends 431, 432, 433, 434 may be received in the recesses 494, 495, 498, 499. In this position, the cover ends 411, 412, 413, 414 and the base ends 431, 432, 433, 434 may be coupled (e.g., welded, brazed, soldered, glued, or the like) to the structure sidewall 420 to form the battery 400.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A battery, comprising:
a cover including a cover main wall and a first cover sidewall extending from the cover main wall at a first substantially perpendicular angle;
a base including a base main wall and a first base sidewall extending from the base main wall at a second substantially perpendicular angle;
a sidewall structure, wherein:
a first end of the sidewall structure is coupled against the cover main wall and the first cover sidewall to define a first interior corner therebetween;
a second end of the sidewall structure is coupled against the base main wall and the first base sidewall to define a second interior corner therebetween;
the first and second interior corners include a substantially zero radius; and
the cover, the base, the sidewall structure, the first interior corner, and the second interior corner define an interior volume; and
a battery cell stack positioned in the interior volume.

2. The battery of claim 1, wherein the substantially zero radius includes a radius of less than 1 mm.

3. The battery of claim 1, wherein:
all interior corners defined between the cover, the base, and the sidewall structure include a substantially zero radius; and
the interior volume is further defined by all interior corners.

4. The battery of claim 1, wherein the first cover sidewall and the first base sidewall respectively extend from an edge of the cover main wall and the base main wall.

5. The battery of claim 1, wherein the cover main wall includes a second cover sidewall extending from the cover main wall transverse to the first cover sidewall and the base main wall includes a second base sidewall extending from the base main wall transverse to the first base sidewall.

6. The battery of claim 5, wherein the first and second cover sidewalls are substantially perpendicular to each other, and the first and second base sidewalls are substantially perpendicular to each other.

7. The battery of claim 1, wherein:
the cover main wall includes a cover extension portion extending exterior to the sidewall structure and the base main wall includes a base extension portion extending exterior to the sidewall structure; and
the cover extension portion lies substantially along a same plane as the cover main wall and the base extension portion lies substantially along a same plane as the base main wall.

8. The battery of claim 1, wherein:
the sidewall structure includes a plurality of sidewall components, each of the sidewall components include a first end and a second end; and
the first ends of the sidewall components are coupled to each other and the second ends of the sidewall components are coupled to each other to define the sidewall structure.

9. The battery of claim 8, wherein:
the first end defines a first slot and includes a first ledge, and the second end defines a second slot and includes a second ledge; and
the first ledge is received in the second slot and the second ledge is received in the first slot.

10. The battery of claim 1,
further comprising:
an electrical contact extending from the interior volume of the sidewall structure to an exterior of the sidewall structure;
a conductive component electrically coupling the battery cell stack to the electrical contact;
wherein:
the battery cell stack is electrically coupled to the conductive component; and
the conductive component includes less than two bends along a length of the conductive component.

11. A battery, comprising:
a cover including a cover main wall and a first cover sidewall extending transversely from the cover main wall;
a base including a base main wall and a first base sidewall extending transversely from the base main wall;
a sidewall structure, wherein:
a first end of the sidewall structure is coupled against the cover main wall and the first cover sidewall to define a first interior corner therebetween;
a second end of the sidewall structure is coupled against the base main wall and the first base sidewall to define a second interior corner therebetween;
the first and second interior corners include a substantially zero radius; and
the cover, the base, the sidewall structure, the first interior corner, and the second interior corner define an interior volume; and
a battery cell stack positioned in the interior volume.

12. The battery of claim 11, wherein the substantially zero radius includes a radius of less than 1 mm.

13. The battery of claim 11, wherein the first cover sidewall extends substantially perpendicularly from the cover main wall and the first base sidewall extends substantially perpendicularly from the base main wall.

14. The battery of claim 11, wherein the cover main wall includes a second cover sidewall extending from the cover main wall transverse to the first cover sidewall and the base main wall includes a second base sidewall extending from the base main wall transverse to the first base sidewall.

15. The battery of claim 11, wherein:
the sidewall structure includes a plurality of sidewall components, each of the sidewall components include a first end and a second end; and
the first ends of the sidewall components are coupled to each other and the second ends of the sidewall components are coupled to each other to define the sidewall structure.

16. A battery, comprising:
a rigid metallic enclosure characterized by an interior volume, wherein the enclosure comprises:
a cover including a cover main wall and a first cover sidewall extending from the cover main wall;
a base including a base main wall and a first base sidewall extending from the base main wall;
a structure sidewall extending between the cover and the base to define a plurality of interior corners having a substantially zero radius, wherein the cover is coupled to the structure sidewall at the first cover sidewall and the base is coupled to the structure sidewall at the first base sidewall; and
a battery cell stack positioned in the interior volume.

17. The battery of claim 16, wherein the first cover sidewall extends from the cover main wall at a first substantially perpendicular angle and the first base sidewall extends from the base main wall at a second substantially perpendicular angle.

18. The battery of claim 16, wherein the substantially zero radius includes a radius of less than 1 mm.

19. The battery of claim 16, wherein:
all interior corners defined between the cover, the base, and the sidewall structure include a substantially zero radius; and
the interior volume is further defined by all interior corners.

20. The battery of claim 16, wherein the cover main wall includes a second cover sidewall extending from the cover main wall transverse to the first cover sidewall and the base main wall includes a second base sidewall extending from the base main wall transverse to the first base sidewall.
